(19) United States
(12) Patent Application Publication
(10) Pub. No.: US 2006/0069904 A1
(43) Pub. Date: Mar. 30, 2006

(54) Information processing apparatus and startup control method

(76) Inventor: Tetsuo Hatakeyama, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/101,965

(22) Filed: Apr. 7, 2005

(30) Foreign Application Priority Data
Sep. 30, 2004 (JP) 2004-288237

(51) Int. Cl. G06F 15/177

(52) U.S. Cl. 713/1

(57) ABSTRACT

According to one embodiment of the invention, the second processor working as a sub-processor starts up when power has been turned on, runs the boot program stored in the ROM, and starts the first processor working as a main processor. After having been started, the first processor loads a DRAM with the boot program to be run by the second processor, and restarts the second processor in such a way that the boot program newly loaded into the DRAM is run by the second processor.

### CROSS REFERENCE TO THE INVENTION

This application is based upon and claims the benefit of priority from the prior Japanese Patent Application No. 2004-288237, filed on Sep. 30, 2004; the entire contents of which are incorporated herein by reference.

### BACKGROUND

1. Field

Embodiments of the present invention relate to an information apparatus comprising a main processor and a sub-processor, and an initialize sequence method.

2. Description of the Related Art

An information apparatus such as a computer generally includes a sub-processor for performing such processing as control of an initialize sequence (startup sequence or boot sequence) and control of a specific input/output device, in addition to a CPU (Central Processor Unit) serving as a main processor. This sub-processor is implemented in the form of a single chip microcomputer or the like. The sub-processor is started first to execute the process of starting (booting) the CPU.

Japanese Patent Application Laid Open No. 2003-271258 discloses a computer equipped with a CPU and EC (Embedded Controller). In this computer, the EC serves the function of the sub-processor. The computer startup sequence is placed under the control of the EC.

As described above, in a system for starting the main processor (CPU) by the sub-processor (EC), the sub-processor is already in the process of running the program, when the main processor has started, and the operation of the sub-processor is under the control of the program being run.

Thus, if the program to be run by the sub-processor (EC) has been tampered, there is no guarantee to ensure the system operation after the main processor has started. Further, extension of the function of the sub-processor (EC) requires a change to be made in the hardware such as the ROM storing the program to be run by the sub-processor.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram representing an exemplary configuration of an information apparatus according to an embodiment of the present invention;

FIG. 2 is a diagram representing an exemplary process to start the second processor (sub-processor) arranged on the information apparatus shown in FIG. 1;

FIG. 3 is an exemplary diagram representing a portion of the process to start the first processor (main processor) arranged on the information apparatus shown in FIG. 1;

FIG. 4 is an exemplary diagram representing the remaining portion of the process to start the first processor (main processor) arranged on the information apparatus shown in FIG. 1;

FIG. 5 is an exemplary diagram representing a part of the process to restart the second processor (sub-processor) arranged on the information apparatus shown in FIG. 1;

FIG. 6 is an exemplary diagram representing the remaining portion of the process to restart the second processor (sub-processor) arranged on the information apparatus shown in FIG. 1; and

FIG. 7 is a flowchart representing the process performed by the first processor (main processor) arranged on the information apparatus shown in FIG. 1.

### DETAILED DESCRIPTION

Embodiments of the invention are implemented to allow the sub-processor to run a required program after the main processor has started, namely placed into an active state. The following describes the various embodiments with reference to the drawings.

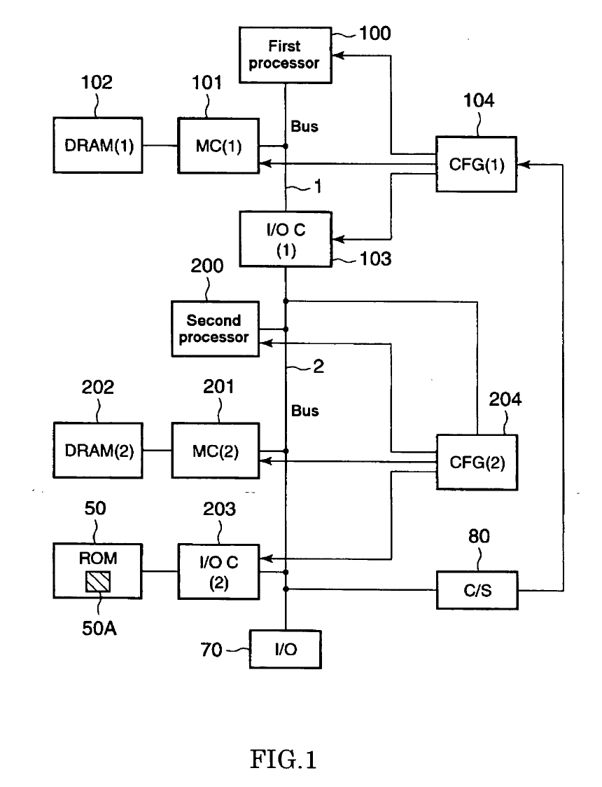

FIG. 1 shows an exemplary configuration of an information apparatus according to one embodiment of the invention. This information apparatus is a computer based on a microprocessor, and is implemented in the form of a personal computer server computer or system incorporated in various electronic devices, for example.

According to one embodiment of the invention, an information processing apparatus 10 comprises a first processor 100, a first memory controller (MC) 101, a first memory (e.g., DRAM) 102, an input/output (I/O) controller 103, a first configuration unit (CFG) 104, a second processor 200, a second memory controller (MC) 201, a second memory (e.g., DRAM) 202, input/output controller 203, a second configuration unit (CFG) 204, a third memory (e.g., ROM) 50, input/output device 70 and a control/status register (C/S) 80.

The second processor 200 controls each component through a bus 2. This second processor 200 serves as a sub-processor to control the startup sequence (initialize sequence or boot sequence) and specific input/output devices such as various operation buttons and input devices. The first processor 100 is initially stopped, namely placed in an inactive state.

The second processor 200 is implemented as a microcomputer. The second processor 200 can be started by either the ROM 50 or DRAM 202. The second configuration unit (CFG) 204 determines whether the ROM 50 or DRAM 202 is used as a boot device. Normally, the second processor 200 uses the ROM 50 as a boot device. For example, when the power is supplied at start-up, the second processor 200 is started up by the ROM 50 to run a boot program stored in the ROM 50.

The second memory controller (MC) 201 is connected with the DRAM 202. The MC 201 controls the DRAM 202 in response to the read/write request from the first processor 100 or second processor 200.

The input/output controller 203 is connected with the ROM 50. The ROM 50 stores a boot program 50A. The boot program 50A is first run by the second processor 200 when the second processor 200 has started operation.

The second configuration unit (CFG) 204 provides the operation setting and starts control of the second processor 200, MC 201 and input/output controller 203. The second configuration unit (CFG) 204 controls the MC 201 and input/output controller 203, and selects either the DRAM 202 or the ROM 50 as a boot device for the second processor 200. To be more specific, when the input/output controller 203 is selected by the CFG 204, the second processor 200 runs the boot program stored in the ROM 50. If the MC 201 is selected by the CFG 204, the second processor 200 runs the boot program stored in the DRAM 202.

After the second processor 200 has started up, the second processor 200 is processing information to start the first processor 100 by placing the first processor 100 into an active state. For instance, according to this embodiment of the invention, the second processor 200 allows the boot program to be run by the first processor 100, in the DRAM 202, and operates the first configuration unit (CFG) 104 via a C/S 80. The first processor 100 serves as a main processor of the present information processing apparatus and executes the operating system and various application programs.

The first processor 100 controls the components connected to the buses 1 and 2.

The first processor 100 runs the boot program loaded on the DRAM 202 by the second processor 200. The first processor 100 has a security function of verifying the validity of the program, and verifies the validity of the boot program loaded on the DRAM 202 by the second processor 200.

The MC 101 is connected with the DRAM 102. In response to the read/write request from the first processor 100, the MC 101 controls the DRAM 102. The I/O controller 103 controls interconnection between the buses 1 and 2.

The first configuration unit (CFG) 104 provides the operation setting and starts control of the first processor 100, MC 101 and I/O controller 103.

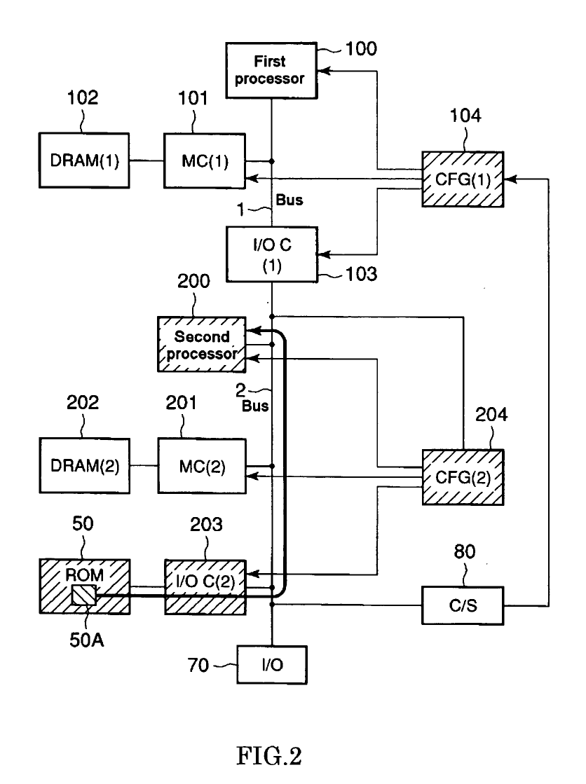

Referring to FIGS. 2 through 6, the following describes the start sequence for starting the information processing apparatus. In the start sequence, the following processing is generally performed as follows:

(1) Start the second processor 200.

(2) Start the first processor 100 using the second processor 200.

(3) Restart the second processor 200 using the first processor 100.

After these operations, the information processing apparatus is put into the normal operation mode.

FIG. 2 shows an exemplary process to start the second processor 200.

When power is supplied to the information processing apparatus, the bus 2, second processor 200, input/output controller 203, ROM 50, CFG 104 and CFG 204 are automatically enabled and placed into an active state. In this case, the CFG 104 disables the first processor 100, MC 101 and I/O controller 103 by placing these components into inactive states. The CFG 204 sets an input/output (I/O) controller 203 automatically to ensure that the ROM 50 is used as a boot device of the second processor 200.

When the information processing apparatus has been turned on, the second processor 200 starts up and runs the boot program 50A stored in the ROM 50. By running the boot program 50A, the second processor 200 enables the MC 201, DRAM 202 and input/output device 70.

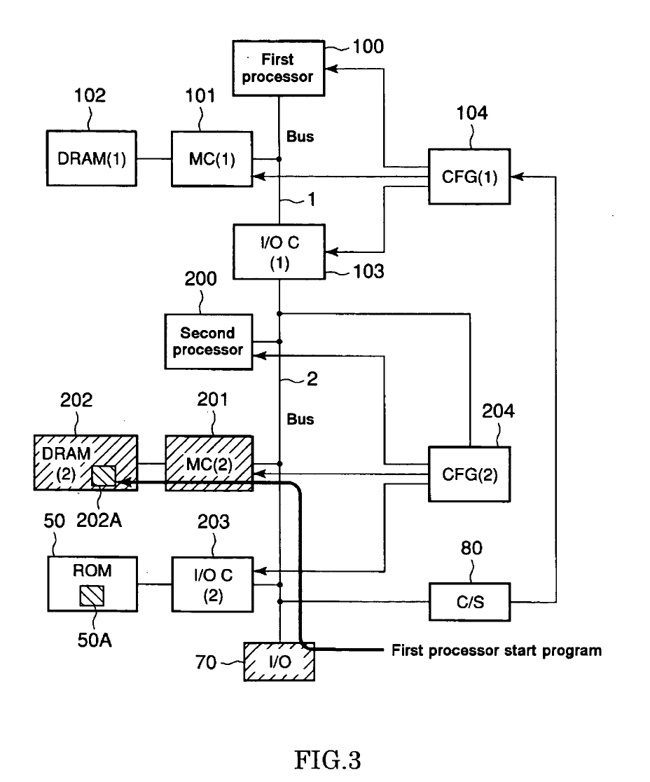

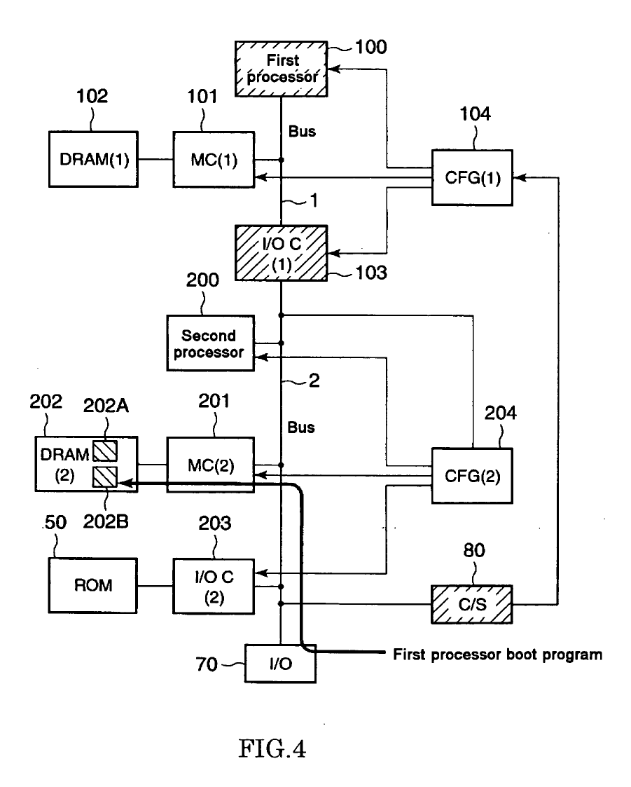

FIGS. 3 and 4 represent the process to start the first processor 100.

By executing the boot program 50A, the second processor 200 loads the program 202A for start control of the first processor 100 from the input/output device 70 such as a hard disk into the DRAM 202, and runs the loaded program 202A. Thereafter, the second processor 200 runs the program 202A, whereby the boot program 202B to be run by the first processor 100 is loaded from the input/output device 70 into the DRAM 202, as shown in FIG. 4. The second processor 200 runs the program 202A, thereby enabling the C/S 80. The second processor 200 operates the CFG 104 through the C/S 80, thereby enabling the first processor 100 and I/O controller 103 by placing these components 100 and 103 into an active state.

In this case, the second processor 200 sets on the CFG 104 the information indicating the storage position of the program to be first executed by the first processor 100, in such a way that the first processor 100 runs the boot program 202B on the DRAM 202. Then the second processor 200 operates the CFG 104 to cancel the resetting of the first processor 100. This arrangement causes the first processor 100 to be started and the first processor 100 starts to run the boot program 202B stored in the DRAM 202. In this case, the first processor 100 verifies the validity of the boot program 202B loaded in the DRAM 202. If the boot program 202B has been found out to be illegal, the start sequence immediately terminates.

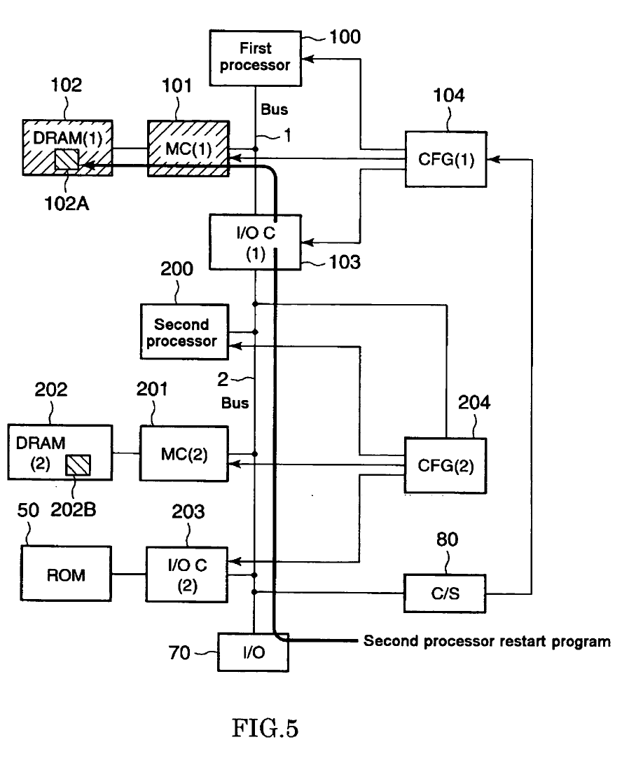

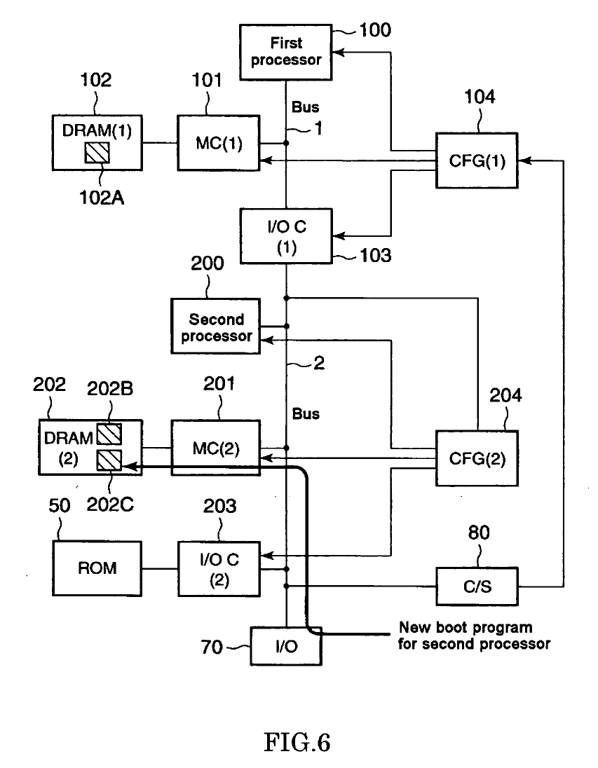

FIGS. 5 and 6 show the process to restart the second processor 200. The first processor 100 runs the boot program 202B, thereby enabling the MC 101 and DRAM 102. Thereafter, the first processor 100 runs boot program 202B, thereby loading the program 102A for restarting the second processor 200, from the input/output device 70 into the DRAM 102. By running the program 102A, the first processor 100 operates the CFG 204 through the I/O controller 103 to stop operating the second processor 200, namely placing the second processor 200 into an inactive state.

This is followed by the operation of the first processor 100 operating the program 102A so that a new boot program 202C to be run by the second processor 200 is loaded from the input/output device 70 into the DRAM 202, as shown in FIG. 6. The first processor 100 operates the CFG 204 to switch the boot device of the second processor 200 over from the ROM 50 to the DRAM 202. This is followed by the operation of the first processor 100 operating the CFG 204 to release the resetting of the second processor 200. This procedure causes the second processor 200 to be restarted and the second processor 200 executes the boot program 202C loaded in the DRAM 202. The boot program 202C comprises a group of instructions for controlling the input/output device or others arranged in the information apparatus.

Then the first processor 100 loads a desired program from the input/output device 70 and starts running the program. This operation causes the information apparatus to be set to the normal operation mode. During the normal operation mode, the second processor 200 correctly performs the processing of controlling the input/output device 70 and others.

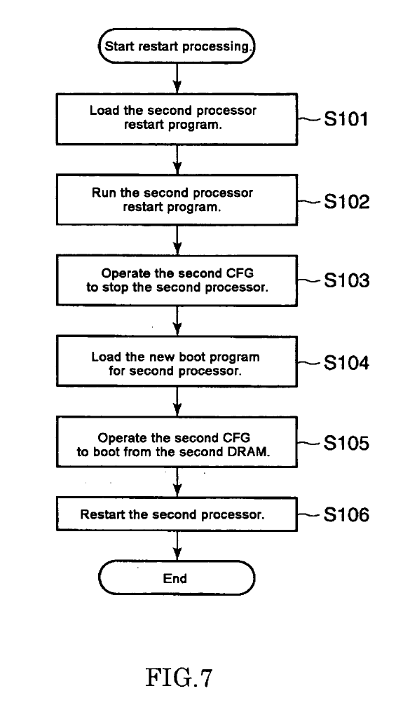

Referring to the flowchart given in FIG. 7, the following describes the procedure of the processing performed by the first processor 100 started by the second processor 200.

The first processor 100 loads the program 102A (second processor restart program) for restarting the second processor 200 from the input/output device 70 (Block S101). The first processor 100 loads the DRAM 102 with the program 102A loaded from the input/output device 70, through the I/O controller 103, and runs the program 102A (Block S102). The first processor 100 operates the CFG 204 to stop the second processor 200 (Block S103). In the Block S103, the first processor 100 operates the CFG 204, thereby resetting the second processor 200, for example.

The first processor 100 loads the boot program 202C to be run by the second processor, from the input/output device 70 (Block S104). In Block S104, the first processor 100 loads the DRAM 202 with the boot program 202C loaded from the input/output device 70.

The first processor 100 operates the CFG 204 so that the second processor 200 starts up from the DRAM 202 (Block S105). In Block S105, the CFG 204 selects the MC 201, thereby allowing the boot device to be switched from the ROM 50 to the DRAM 202.

The first processor 100 releases the resetting of the second processor 200 and restarts the second processor 200, whereby the second processor 200 runs the new boot program 202C stored in the DRAM 202.

According to the present embodiment, as described above, after the first processor 100 has been started by the second processor 200, the second processor 200 is restarted under the control of the first processor 100, and the second processor 200 runs a new program automatically. This process allows the second processor 200 to run a desired program.

Thus, after the first processor 100 has been started, the operation of the second processor 200 is controlled by a new program loaded by the first processor 100. Thus, even if the boot program 50A in the ROM 50 has been tampered, the operation of the second processor 200 can be assured as long as the first processor 100 is started correctly.

The present embodiment has been described with reference to the case where the boot program 50A and boot program 202C are stored in the ROM 50 and DRAM 202, respectively. However, the boot program 50A and boot program 202C can be stored in two different storage areas on the DRAM 202, respectively. In this case, these two storage areas function as boot areas.

It is to be expressly understood, however, that the present invention is not restricted to the embodiments described above. The present invention can be embodied in a great number of variations of the components, without departing from the technological spirit of the invention claimed. It can be formed into various inventions by appropriate combinations of a plurality of components. For example, some of the components shown in the aforementioned embodiment can be eliminated. Further, these components can be appropriately combined to form a different embodiment.

What is claimed is:

1. An information processing apparatus comprising:
a main processor initially placed into an inactive state;
a sub-processor adapted to execute a first program stored in a first storage area and to place the main processor into an active state;
a memory controller controlled by the main processor to load a second program within a second storage area when the sub-processor is placed into an inactive state; and
a first configuration unit controlled by the main processor to place the sub-processor into the inactive state and subsequently place the sub-processor in an active state thereby restarting the sub-processor to execute the second program loaded in the second storage area.

2. The information processing apparatus according to claim 1, wherein the first configuration unit switching a boot area prior to the sub-processor being restarted from the first storage area to the second storage area.

3. The information processing apparatus according to claim 1 further comprising an input/output (I/O) device in communication with the sub-processor and the main processor, the I/O device controlled by the sub-processor executing the first program (i) to load a third program within the second storage area, the third program executed by the sub-processor to start the main processor and (ii) to load a boot program for the main processor into the second storage area.

4. The information processing apparatus according to claim 1, wherein the first storage area comprises a non-volatile memory, and the second storage area comprises a volatile memory.

5. The information processing apparatus according to claim 1, wherein the main processor, after placed into the active state, verifies the validity of the boot program loaded into the second storage area.

6. The information processing apparatus according to claim 5, wherein the main processor having verified the validity of the boot program loads a fourth program into a third storage area, the fourth program upon executed by the main processor restarting the sub-processor.

7. The information processing apparatus according to claim 1 further comprising a second configuration unit coupled to the first processor and an input/output controller further coupled to the first configuration unit, the second configuration unit being used to place the main processor into the active state.

8. A method for controlling startup of an information processing apparatus including a main processor and a sub-processor, comprising:
(a) starting the main processor by the sub-processor;
(b) stopping the sub-processor by the main processor;
(c) loading a first program by the main processor into a first storage area accessible by the sub-processor;
(d) restarting the sub-processor; and
(e) executing the first program by the sub-processor.

9. The method according to claim 8, wherein prior to stopping the sub-processor, the method further comprising:
verifying validity of a boot program by the main processor where operations (b)-(e) occur if the boot program is determined to be valid.

10. The method according to claim 8, wherein the loading of the first program by the main processor into the first storage area comprising switching a boot area of the sub-processor from a second storage area within a second memory to the first storage area within a first memory before the sub-processor has restarted operation.

11. The method according to claim 9, wherein the starting of the main processor comprises (i) loading a second program by the sub-processor into the first memory, the second program configured to restart the main processor, and (ii) executing the second program by the sub-processor to cause (a) the boot program for the main processor to be loaded into the first memory before the main processor is started, and (b) the main processor to be started.

12. A method comprising:
starting a second processor by a first processor of an information processing apparatus;
stopping the first processor;
restarting the first processor under control by the second processor; and
executing a boot program by the first processor.

13. The method according to claim 12, wherein prior to starting the second processor, the method further comprises
accessing and executing an initial boot program within a first storage area by the first processor.

14. The method according to claim 13, wherein prior to restarting the first processor, the method further comprises
configuring the information processing apparatus so that the first processor accesses a second storage area rather than the first storage area; and
loading the boot program by the second processor into the second storage area.

15. The method according to claim 14, wherein the configuring of the information processing apparatus so that the first processor accesses the second storage area is handled by transmitting a signal to a configuration unit, accessible to the second processor via an input/output controller, to select the second storage area as a boot device for the first processor.

16. The method according to claim 12, wherein prior to starting the first processor, the method comprising loading a memory accessible by the second processor with a boot program to be verified prior to execution by the second processor.

17. The method according to 12, wherein the starting of the first processor includes the second processor setting a register to signal a first configuration unit to deactivate a reset signal applied to the first processor from the first configuration unit.

18. The method according to 12, wherein the starting of the first processor includes the second processor setting a register to signal a first configuration unit to enable the first processor and an input/output controller coupled to a second configuration unit controlling the second processor.

19. An information processing apparatus comprising:
a first processor initially placed in an inactive state and executing a first boot program;
a second processor initially placed in an active state;
a first configuration unit controlled by the second processor to place the first processor into an active state; and
a second configuration unit controlled by the first processor to place the second processor into an inactive state and subsequently place the second processor in the active state thereby restarting the second processor to execute a second boot program.

20. The information processing apparatus according to claim 19 further comprising:
a plurality of memory elements including a first memory element and a second memory element, the first memory element adapted to store the first boot program and the second memory element adapted to store the second boot program loaded after the first processor is placed in the inactive state.
